(19) United States
(12) Patent Application Publication
(10) Pub. No.: US 2013/0219873 A1
(43) Pub. Date: Aug. 29, 2013

(54) NEW MECHANISM FOR FLUID POWER TRANSMISSION AND CONTROL

(71) Applicant: Xuejun Xu, Thomastown (AU)

(72) Inventor: Xuejun Xu, Thomastown (AU)

(21) Appl. No.: 13/880,805

(22) PCT Filed: Oct. 26, 2011
(86) PCT No.: PCT/AU2011/001361

§ 371 Date: Apr. 22, 2013

(30) Foreign Application Priority Data
Oct. 30, 2010 (AU) 2010238562

(51) Int. Cl. F15B 15/18

(52) U.S. Cl. CPC F15B 15/18
USPC 60/325

(57) ABSTRACT

This Mechanism introduces a new concept for rotary valves used in fluid power transmission and control. It transforms the rotary motion precisely to axial straight motion. It can also be used as an actuator. There are two sensitive chambers at the ends of the spool. Four helical grooves operate in axial symmetry. The rotary motion of the helical groove changes the connections/distribution between ports and chambers, thus forces the spool to slide to a balanced position.

The rotary valves in Fluid Power Transmission and Control normally operate in two ways. One just combines a traditional spool valve with a mechanical screw device, transforming rotary motion into axial motion, and the other uses longitudinal grooves on the surface of a spool to switch the connection/distribution between different ports. These two fluid-power transmission and control mechanisms are complicated to manufacture and have low frequency reactions.

This invention introduces a new concept for rotary valves used in fluid power transmission and control. It transforms the rotary motion precisely to axial straight motion. It can also be used as an actuator.

Before explaining the details of this invention, some symbols need to be defined:

P: The fluid power inlet port (high pressure)

T: The port that connects to the tank or the reservoir line (low pressure)

In order to demonstrate the main functions clearly, other structural details such as spool lands, seals, centering springs, etc. are out of consideration.

FIG. (1) shows the simplified cross section of this mechanism. There are two sensitive chambers at the ends: C1 and C2. The fluid pressure in C1 acts on the spool in area A1, and the fluid pressure in C2 acts on the spool in area A2. A1 is larger than the annular area of A2. Four helical grooves operate in axial symmetry; two of them connect C1, while the others connect C2. On the surface of the bore, the two ports P and two ports T get covered by the helical teeth as they, too, operate in axial symmetry. The fluid pressure in C1 is P1, and the fluid pressure in C2 is P2. The axial force caused by fluid pressure acts on the spool in C1 (A1×P1) tends to push the spool rightwards, and the axial force caused by fluid pressure in C2 (A2×P2) tends to push the spool leftwards, creating a balanced state:

P1×A1=P2×A2

FIG. (2) shows the connection of ports after the spool rotates in an anti-clockwise direction. The rotary motion of the helical groove makes the port P open the channel to C1, increasing the fluid pressure P1. Meanwhile, C2 connects to port T, decreasing the fluid pressure P2, so, P1×A1>P2×A2, forcing the spool rightwards. This rightwards slide motion of the spool forces the helical teeth to gradually block ports P and T until the fluid pressure in the chambers reverts to the balanced state, P1×A1=P2×A2.

FIG. (3) demonstrates balanced state. The spool has moved a distance rightwards.

FIG. (4) shows the connections of the ports after the spool rotates in a clockwise angle. C1 connects to port T, decreasing the fluid pressure P1. Meanwhile, C2 connects to port P, increasing the fluid pressure P2. Thus P1×A1<P2×A2, forcing the spool to move leftwards. This leftwards slide motion of the spool forces the helical teeth to gradually block ports P and T until the fluid pressure in the chambers reverts to the balanced state, P1×A1=P2×A2.

FIG. (5) demonstrates the balanced state. The spool has moved a distance leftwards.

Furthermore, in many conditions the chamber with the small area is always connected to a high-pressure port P. This efficiently simplifies the structure.

FIG. (6) shows the simplified mechanism. The chamber C2 is always connected to port P, so P2=P. There are only two helical grooves, axial symmetry, connect C1. Fluid pressure in C1=P1. The fluid pressure acts on the spool in C1 (A1×P1), tending to push the spool rightwards, and the axial force cased by the fluid pressure acts on the spool in C2 (A2×P), tending to push the spool leftwards, creating a balanced state:

P1=P×A2/A1; P1×A1=P×A2.

FIG. (7) shoes the connections of the ports after the spool rotates in an anti-clockwise direction. C1 connects port P, increasing the fluid pressure in C1 (P1), so, P1×A1>P×A2. The spool is then moved rightwards. The rightwards slide motion of the spool forces the helical teeth to gradually block port P until the fluid pressure in C1 (P1) is reverted to a balanced state, P1=P×A2/A1; P1×A1=P×A2

FIG. (8) demonstrates the balanced state. The spool has moved a distance rightwards.

FIG. (9) shows the connections of the ports after the spool rotates in a clockwise direction. C1 connects to port T, decreasing the fluid pressure P1, so, P1×A1<P×A2. The spool is then moved leftwards. The leftwards slide motion of the spool forces the helical teeth to gradually block port T until the fluid pressure in C1 (P1)is reverted to a balanced state:

P1=P×A2/A1; P1×A1=P×A2

FIG. (10) demonstrates the balanced state. The spool has moved a distance leftwards.

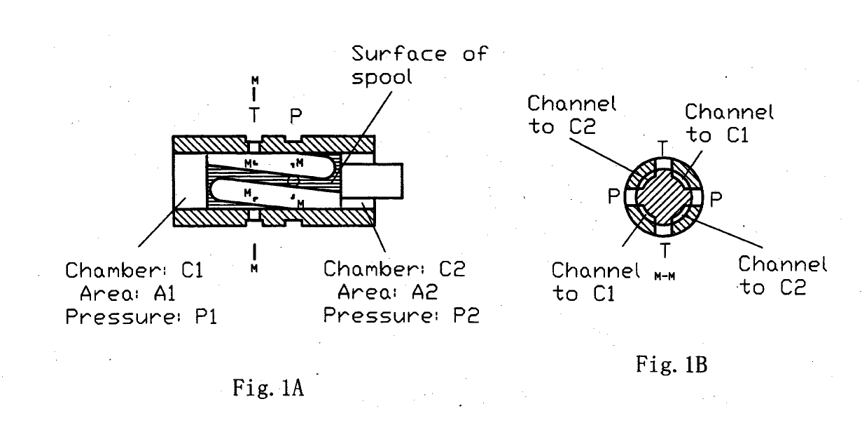

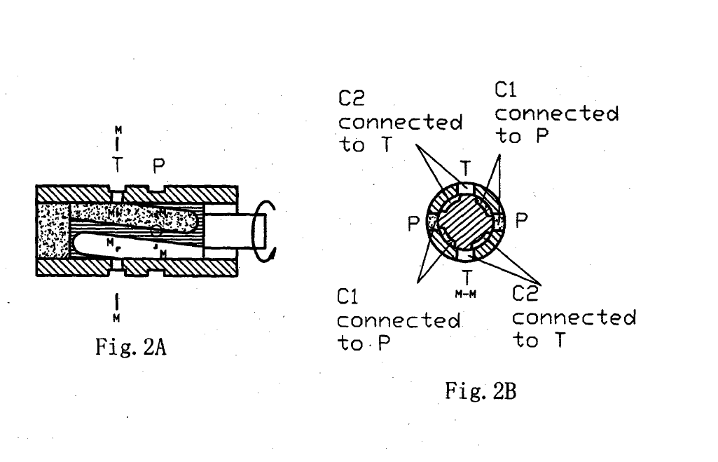

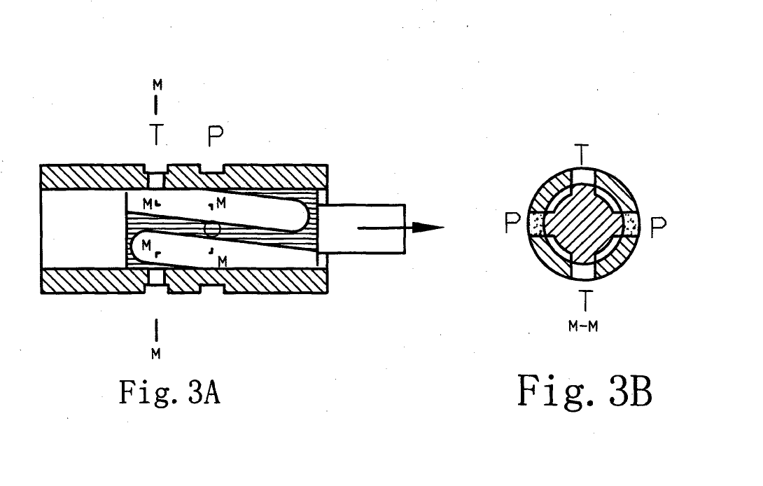

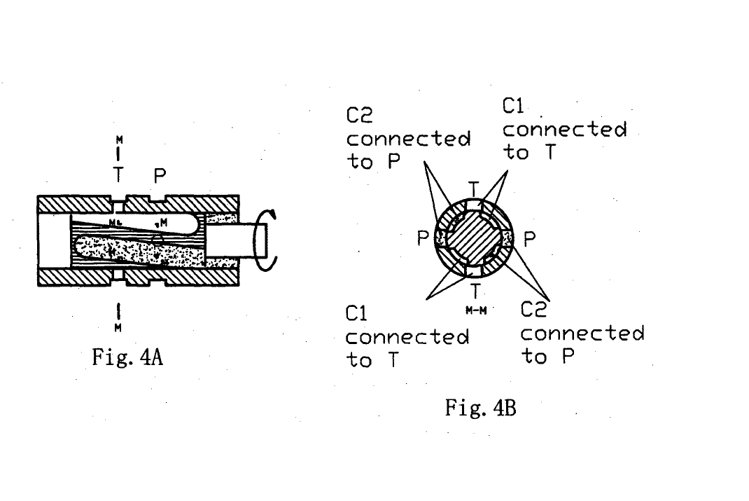

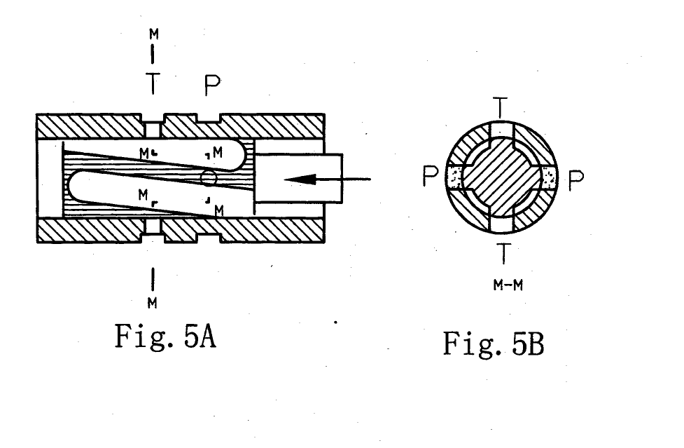

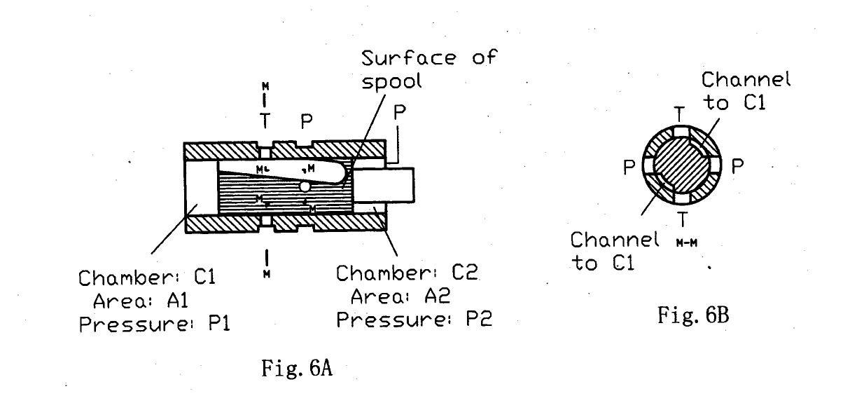

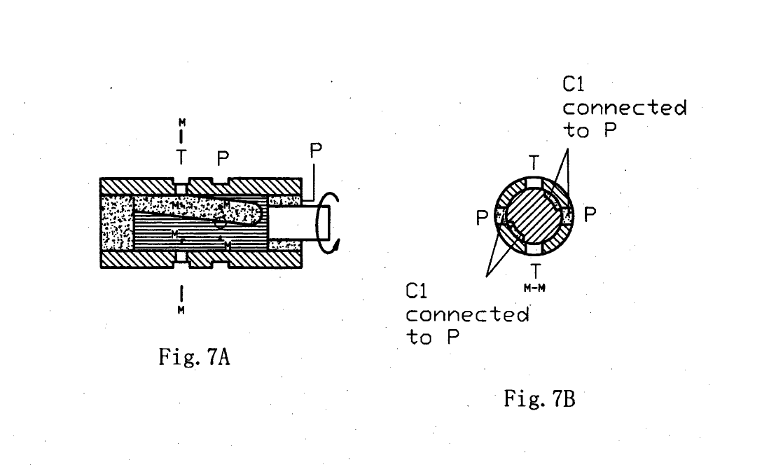

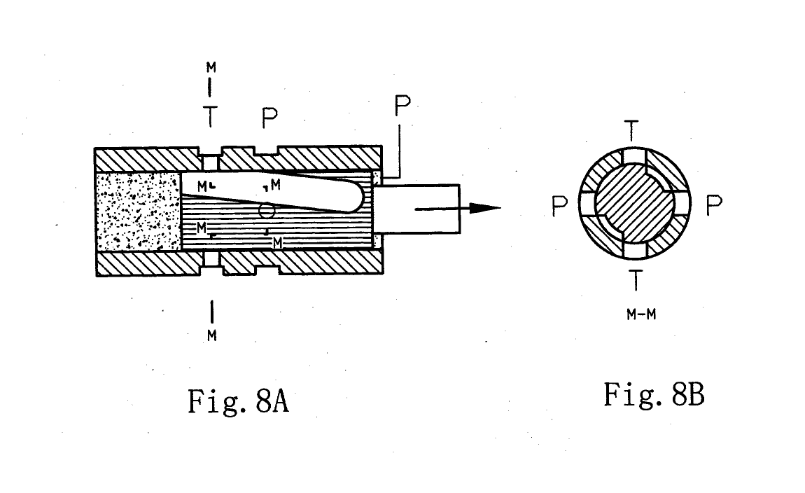

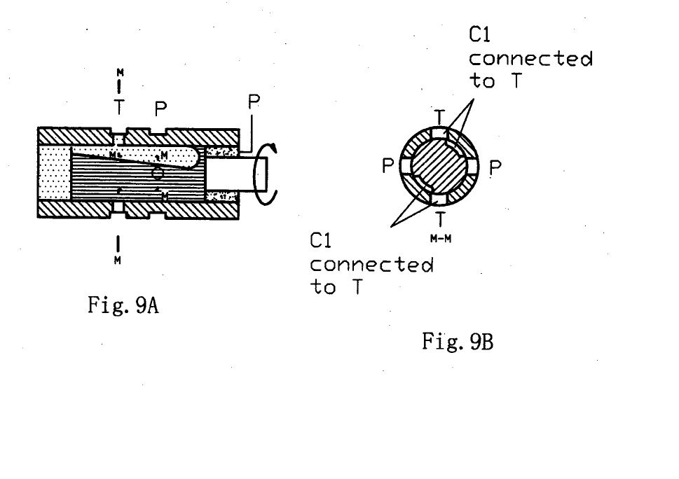

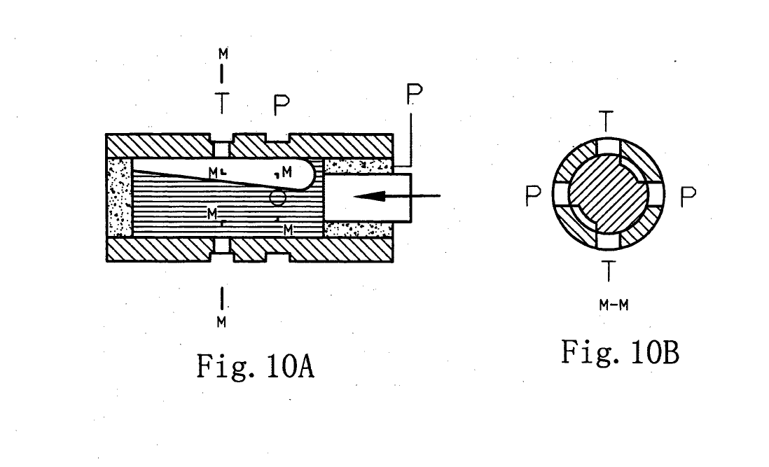

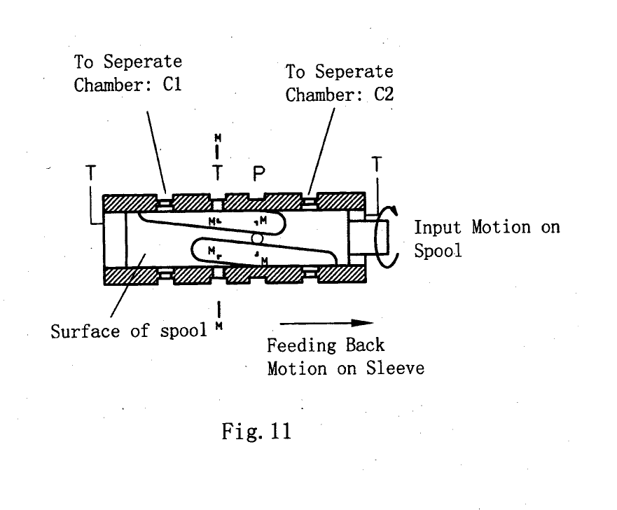

This mechanism can also be transformed to a servo amplifier or a transducer in a closed loop. For example, as shown on FIG. 11), the spool rotates clockwise as input. The fluid pressure and flow rate are then transmitted out to separate chambers built in other parts. As a result, the fed-back rightwards motion accomplished by other parts acts on the sleeve.

The aforesaid motions are all relative to each other between the spool and the sleeve.

For instance, if the spool rotates anti-clockwise, it may mean that the sleeve rotates clockwise in reality, and vice versa. The straight slide movement is the same.

In conclusion, this invention sets up a pilot function on the main spool and optimally utilises the characteristics of helical grooves.

1-13. (canceled)

14. A mechanism that transfers rotary motion to axial straight motion, comprising:
A. A spool with at least one group of helical grooves that is in axial symmetry and is at least partially recessed into its surface;
B. A sleeve has two groups of ports on the surface of the bore which is associated with the foresaid spool and each group consists of at least two ports located in axial symmetry, whereby one group of ports (ports P) is in permanent flow communication with the high pressure line, and the other group (ports T), is in permanent flow communication with the low pressure line;
C. At least two sensitive chambers urge the said spool in opposing directions and at least one of them is in permanent flow communication with one group of said helical grooves so that the pressure in this sensitive chamber is controlled by this group of helical grooves in a way that when this group of helical grooves opens to the said ports P, the pressure in this sensitive chamber rise up; and when this group of helical grooves opens to the said ports T, the pressure in this sensitive chamber drops down;
whereby each said group of helical grooves operates in a way that when the said spool rotates in one direction, all the helical grooves in this group are opened directly to one of the said group of ports P and group of ports T; and when the said spool rotates in the other direction, all the helical grooves in this group are opened directly to the other of the said group of ports P and group of ports T;
whereby when the said spool rotates, the pressure in each said sensitive chamber which is in permanent flow communications with said helical grooves changes, resulting in a force imbalance on said spool, thereby moving the said spool until it retrieves to a force balanced state.

15. The sensitive chambers mentioned in claim 14 are built up independent of the spool and sleeve mentioned in claim 1.

16. The spool mentioned in claim 14 is spring centered.

17. The spool mentioned in claim 14 is a main spool.

18. The spool mentioned in claim 14 is structured with a rod extending at least on one end.

19. The sleeve mentioned in claim 14 acts as a housing of the mechanism mentioned in claim 1.

20. The spool mentioned in claim 18 is structured so that the rod extending is substituted by a coupling operable coupled to the said spool.
